(19) United States
(12) Patent Application Publication
(10) Pub. No.: US 2011/0107410 A1
(43) Pub. Date: May 5, 2011

(54) METHODS, SYSTEMS, AND COMPUTER PROGRAM PRODUCTS FOR CONTROLLING SERVER ACCESS USING AN AUTHENTICATION SERVER

(75) Inventor: Anthony B. Dargis, Flemington, NJ (US)

(73) Assignee: AT&T Intellectual Property I,L.P.

(21) Appl. No.: 12/610,411

(22) Filed: Nov. 2, 2009

(51) Int. Cl. H04L 29/06; G06F 17/00

(52) U.S. Cl. 726/9; 726/11

(57) ABSTRACT

An access request message is received at an authentication server computer, the access request message identifying an address of an access requesting client device. The authentication server authenticates the access request message and transmits an access authorization message from the authentication server computer to a blocking device that controls access to the protected server computer, the access authorization message identifying the address of the access requesting client device. Access to the protected server computer via the blocking device is controlled responsive to the access authorization message.

### BACKGROUND OF THE INVENTION

The present application relates generally to computer networks and, more particularly, to methods, systems and computer program products for controlling access to a server.

Internet-connected devices, such as servers that provide various retail or other e-commerce services, are often subject to attack from unauthorized users. Such attacks may compromise confidential information or consume server resources.

A variety of techniques have been devised for protecting such devices. For example, a server (or a device protecting a network including the server) may maintain a “whitelist” of internet addresses that are allowed to access the server. However, such whitelists may need to be updated (often manually) as users move from one location to another. Other techniques for protection include “port knocking,” in which a coded sequence of TCP (transmission control protocol) SYN (synchronize) requests to specific ports to authenticate a user, and “single packet authorization” (SPA), in which a specially coded packet authenticates a user and data.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Some embodiments provide methods of controlling access to a protected server computer. An access request message is received at an authentication server computer, the access request message identifying an address of an access requesting client device. The authentication server authenticates the access request message and transmits an access authorization message from the authentication server computer to a blocking device that controls access to the protected server computer, the access authorization message identifying the address of the access requesting client device. Access to the protected server computer via the blocking device is controlled responsive to the access authorization message. Controlling access to the protected server computer via the blocking device may include modifying an access control list (ACL) at the blocking device based on the access authorization message. Controlling access to the protected server computer via the blocking device responsive to the access authorization message may include controlling access to a network including the protected server computer responsive to the access authorization message. The access authorization message may be a secure access authorization message, such as a Simple Network Management Protocol version 3 (SNMPv3) message. The access request message may be authenticated using a security token, a password, a pass-phrase and/or an identifier.

Further embodiments provide a system including an authentication server computer configured to receive an access request message identifying an address of an access requesting client device, to authenticate the access request message and to transmit an access authorization message responsive to authentication of the access request message, the access authorization message identifying the address of the access requesting client device. The system further includes a blocking device configured to receive the access authorization message from the authentication server computer and to control access to a protected server computer by the access requesting client device responsive to the received access authorization message.

Additional embodiments provide an authentication server including a communications interface circuit configured to receive an access request message identifying an address of an access requesting client device and an authentication circuit configured to authenticate the access request message. The communications interface circuit is further configured to transmit an access authorization message from the authentication server computer to a blocking device that controls access to the protected server computer responsive to authentication of the access request message, the access authorization message identifying the address of the access requesting client device.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram illustrating systems and methods for managing server access in accordance with some embodiments;

FIG. 2 is a block diagram illustrating an authentication server and blocking device in accordance with some embodiments;

FIG. 3 is a flowchart that illustrates operations methods, systems, and computer program products in accordance with some embodiments.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations discussed herein may be written in a high-level programming language, such as Java, C, and/or C++, for development convenience. In addition, computer program code for carrying out operations according to some embodiments may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Embodiments are described hereinafter with reference to flowchart and/or block diagram illustrations of methods, systems, client devices, and/or computer program products in accordance with some embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

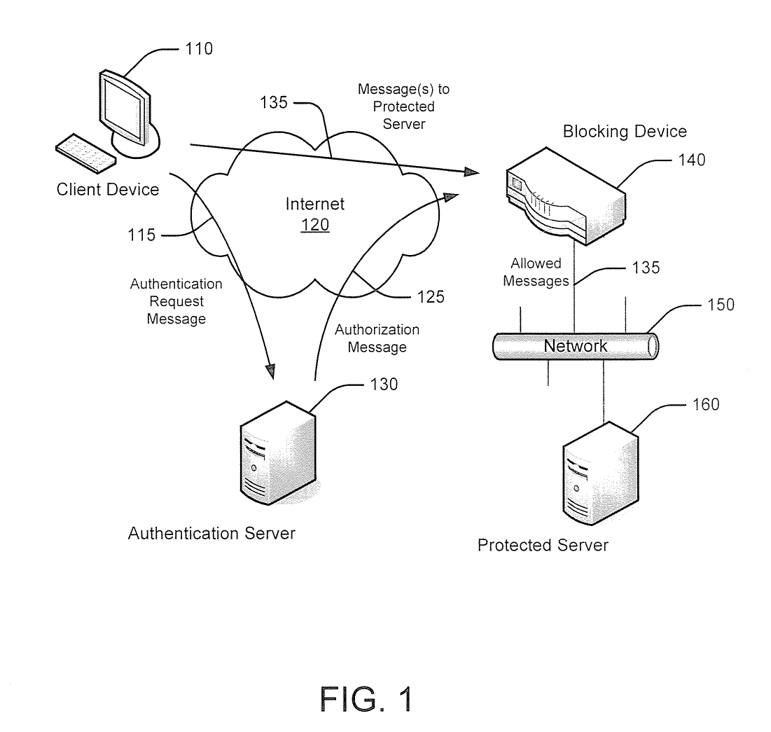

FIG. 1 illustrates access control systems and methods according to some embodiments of the present invention. A protected server 160 is protected by a blocking device 140. As shown, for example, the protected server 160 may be a part of a network 150, the access to which is controlled by the blocking device 140. The blocking device 140 may, for example, allow only control packets and packets from authorized network (e.g., IP) addresses to access the network 150. The blocking device 140 may be located, for example, at a customer's premises (e.g., in customer equipment) or may be located in the network 150 (e.g., in network equipment controlled by a network provider). The latter configuration may be advantageous for network providers, as it can retain control of security features in the network provider's infrastructure.

An authentication server 130 is configured to authenticate requests for access to the protected server 160 and to provide instructions to the blocking device 140 to allow or reject messages from certain addresses. By allowing traffic from only authorized addresses, the protected server 160 (and/or the network 150) becomes invisible to other traffic. This can reduce or prevent random attacks against the protected server 160, such as scanning, denial of service and spoofing attacks.

The authentication server 130 may receive an authentication request message 115 from a client device 110 over a network, for example, the Internet 120. The access request message 115 identifies the client device 110 and requests access to the protected server 160 via the blocking device 140 and network 150. In response to receipt of the access request message 115, the authentication server 130 authenticates the access request message 115, e.g., verifies that the client device 110 is authorized to access the protected server 160. In responsive to authentication, the authentication server 130 may send an authorization message 125 to the blocking device 140, which may responsively modify its security configuration, for example, its access control list (ACL), to allow authorized messages 135 from the authorized client device 110 to pass to the network 150 and on to the protected server 160. The authorization message 125 may be, for example, a single Simple Network Management Protocol version 3 (SNMPv3) message that supports authentication, message integrity and encryption of the management payload. The authorization message 125 may be encrypted and time-stamped to reduce or prevent eavesdropping and replay attacks.

The authentication server 130 may be, for example, a secure socket layer (SSL) enabled web server. Depending on security requirements, examples of authentication processes that may be used include processes involving one-time use of a security token, processes using an ID with password or pass-phrase, processes using a user-entered ID and/or processes using an ID included in an http request string. The authentication server 130 may be configured to handle requests for multiple protected servers and/or networks, and may scale based on the number of servers/networks protected.

The blocking device 140 may be, for example, a router with an application blade or a Linux server. In some embodiments, the network 150 may be a network of a customer of a vendor that operates the authentication server 130. As a service to the customer, the vendor may provide the blocking device 140 to control access to the customer's network 150, which may also have its own internal security structure. The blocking device 140 may, for example, block all traffic that is not specifically authorized by its ACL, while also listening for SNMPv3 authorization messages 125 from the authentication server 130.

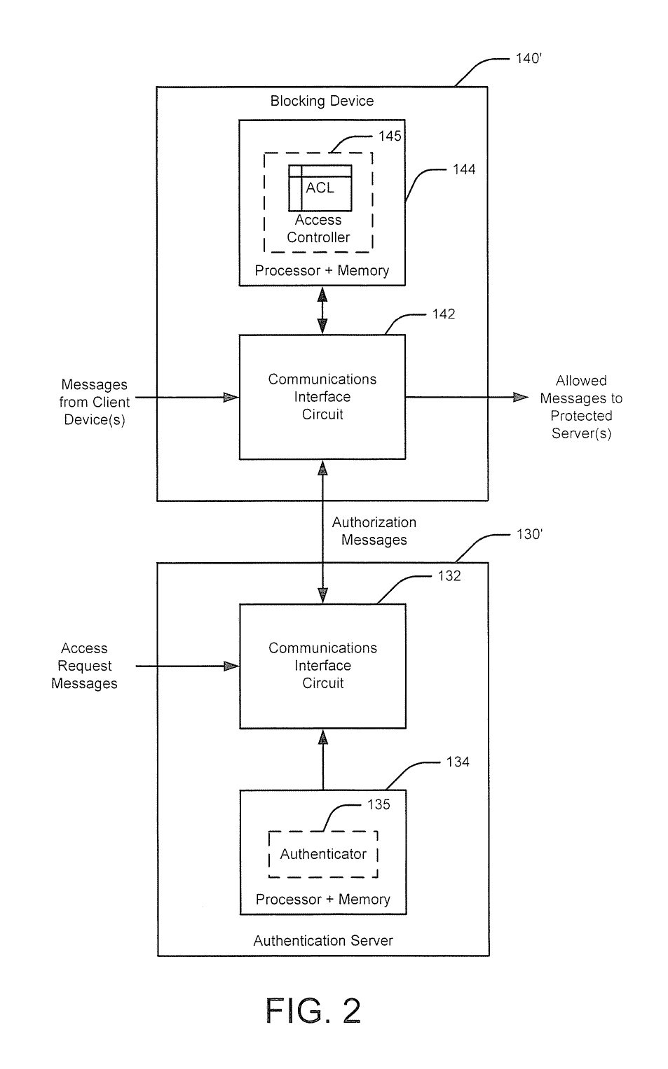

FIG. 2 illustrates implementation of an authentication server 130′ and a block device 140′ according to some embodiments. The authentication server 130′ comprises a computer device including a processor and associated memory (internal and/or external) 134, which is configured to send and receive messages via a communications interface circuit 132. Access request messages received via the communications interface circuit 132 are authenticated by an authenticator circuit 134, here shown as implemented using program code 135 that is executed by the processor and memory combination 134. The authenticator circuit 134 may, for example, examine identification information in the received access request messages and responsively generate authorization messages that are transmitted to the blocking device 140′ via the communications interface circuit 132.

The blocking device 140′ may be computer device that includes a processor and associated memory 144 which is communicatively coupled to a communications interface circuit 142. The communications interface circuit 142 is configured to receive authorization messages from the authentication server 130′. As illustrated, the processor and memory 144 is configured to provide an access controller 144 that maintains an ACL based on the received authorization messages. The communications interface circuit 142 is further configured to receive messages from client devices that are addressed to a server/network protected by the blocking device 140′. The access controller 144 controls transmission of the received messages on to the protected server based on the ACL.

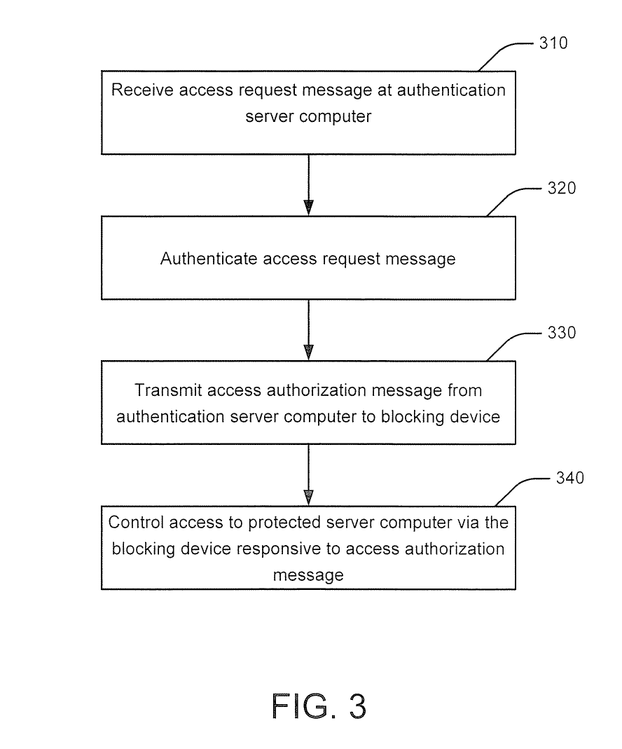

FIG. 3 illustrates operations for controlling access to a protected server according to some embodiments. An authentication server receives an access request message from a client device, the access request message requesting access to the protected server and identifying an address for the requesting client device (block 310). The authentication server authenticates the access request message (block 320) and responsively transmits an authorization message identifying an address of the requesting client device to a blocking device that controls access to the protected server (block 330). The blocking device controls access to the protected server based on the authorization message, e.g., adds the address of the authorized requesting client device to its ACL (block 340).

Potential advantages in some embodiments may include allowing the blocking device to be invisible to messages other than those from authorized addresses and messages from the authentication server. Even if the authentication credentials become compromised, the existing security structure of the protected server can detect unauthorized intrusion, and the intrusion's visibility may be enhanced by the filtering effect of the blocking device, which can reduce significantly lower the number of intrusions actually reaching the protected server. Authentication can be moved to the network and performed on a device (the authentication server) that is optimized for the function.

In some embodiments, performance may be enhanced by limiting the number of potential source addresses that may be accepted by a blocking device, as an ACL with an overly large number of authorized source addresses may present performance issues. It may also be desirable to limit the number of applications and hosts, as sites that run multiple applications and/or hosts may be more vulnerable to attack and/or misconfiguration.

Many variations and modifications can be made to the embodiments without substantially departing from the principles of the present invention. All such variations and modifications are intended to be included herein within the scope of the present invention, as set forth in the following claims.

That which is claimed:

1. A method of controlling access to a protected server computer, the method comprising:
receiving an access request message at an authentication server computer, the access request message identifying an address of an access requesting client device;
authenticating the access request message at the authentication server computer; and
responsive to authentication of the access request message, transmitting an access authorization message from the authentication server computer to a blocking device that controls access to the protected server computer, the access authorization message identifying the address of the access requesting client device.

2. The method of claim 1, further comprising controlling access to the protected server computer via the blocking device responsive to the access authorization message.

3. The method of claim 2, wherein controlling access to the protected server computer via the blocking device responsive to the access authorization message comprises modifying an access control list (ACL) at the blocking device based on the access authorization message.

4. The method of claim 2, wherein controlling access to the protected server computer via the blocking device responsive to the access authorization message comprises controlling access to a network comprising the protected server computer responsive to the access authorization message.

5. The method of claim 1, wherein transmitting an access authorization message from the authentication server computer to a blocking device that controls access to the protected server computer comprises transmitting a secure access authorization message.

6. The method of claim 1, wherein transmitting a secure access authorization message comprises transmitting a Simple Network Management Protocol version 3 (SNMPv3) message.

7. The method of claim 1, wherein authenticating the access request message comprises authenticating the access request message using a security token, a password, a pass-phrase and/or an identifier.

8. The method of claim 1, wherein the protected server comprises customer equipment served by network provider infrastructure that comprises the blocking device.

9. A computer-readable medium having computer code configured to perform the method of claim 1 embodied therein.

10. A system comprising:
an authentication server computer configured to receive an access request message identifying an address of an access requesting client device, to authenticate the access request message and to transmit an access authorization message responsive to authentication of the access request message, the access authorization message identifying the address of the access requesting client device; and
a blocking device configured to receive the access authorization message from authentication server computer and to control access to a protected server computer by the access requesting client device responsive to the received access authorization message.

11. The system of claim 10, wherein the blocking device is configured to modify an access control list (ACL) responsive to the access authorization message.

12. The system of claim 10, wherein the blocking device is configured to control access to a network comprising the protected server computer responsive to the access authorization message.

13. The system of claim 10, wherein the access authorization message comprises a secure access authorization message.

14. The system of claim 13, wherein the access authorization message comprises a SNMPv3 message.

15. The system of claim 10, wherein the authentication server computer is configured to authenticate the access request message using a security token, a password, a pass-phrase and/or an identifier.

16. The system of claim 10, wherein the protected server comprises customer equipment served by network provider infrastructure that comprises the blocking device.

17. An authentication server comprising:
a communications interface circuit configured to receive an access request message identifying an address of an access requesting client device; and
an authenticator circuit configured to authenticate the access request message,
wherein the communications interface circuit is further configured to transmit an access authorization message from the authentication server computer to a blocking device that controls access to the protected server computer responsive to authentication of the access request message, the access authorization message identifying the address of the access requesting client device.

18. The authentication server of claim 17, wherein the access authorization message comprises a secure access authorization message.

19. The authentication server of claim 18, the secure access authorization message comprises a SNMPv3 message.

20. The authentication server of claim 17, wherein the authenticator circuit is configured to authenticate the access request message using a security token, a password, a pass-phrase and/or an identifier.
